(19) United States
(12) Patent Application Publication
(10) Pub. No.: US 2015/0114701 A1
(43) Pub. Date: Apr. 30, 2015

(54) MULTILAYER CERAMIC CAPACITOR AND BOARD WITH THE SAME MOUNTED THEREON

(71) Applicant: Samsung Electro-Mechanics Co., Ltd., Suwon-Si (KR)

(72) Inventors: Hae Sock CHUNG, Suwon-Si (KR); Doo Young KIM, Suwon-Si (KR); Chang Hoon KIM, Suwon-Si (KR); Sun Cheol LEE, Suwon-Si (KR); Jong Hyun YOON, Suwon-Si (KR); Ki Won KIM, Suwon-Si (KR)

(73) Assignee: SAMSUNG ELECTRO-MECHANICS CO., LTD., Suwon-Si (KR)

(21) Appl. No.: 14/262,345

(22) Filed: Apr. 25, 2014

(30) Foreign Application Priority Data
Oct. 30, 2013 (KR) 10-2013-0130472

(51) Int. Cl. H01G 4/12; H01G 2/06

(52) U.S. Cl. CPC H01G 4/12; H01G 2/065; H01G 4/1236; H01G 4/1218
USPC 174/260; 361/321.2

(57) ABSTRACT

A multilayer ceramic capacitor may include a ceramic body including dielectric layers, first and second internal electrodes disposed in the ceramic body to face each other, the dielectric layer being interposed between the first and second internal electrodes, and first and second external electrodes covering both end surfaces of the ceramic body. The ceramic body may include an active layer as a capacitance forming part and a cover layer as a non-capacitive part disposed on at least one surface of upper and lower surfaces of the active layer, the cover layer including at least one buffer layer, and when a thickness of the cover layer is defined as tc, and a thickness of the buffer layer is defined as ti, ti/tc being in a range of 0.15 to 0.90 (0.15≦ti/tc≦0.90).

### CROSS-REFERENCE TO RELATED APPLICATION

This application claims the benefit of Korean Patent Application No. 10-2013-0130472 filed on Oct. 30, 2013, with the Korean Intellectual Property Office, the disclosure of which is incorporated herein by reference.

### BACKGROUND

The present disclosure relates to a multilayer ceramic capacitor and a board with the same mounted thereon.

In accordance with the recent trend toward miniaturization of electronic products, the demand for miniaturized and high capacitance multilayer ceramic electronic components has increased.

Therefore, dielectric layers and internal electrodes have been thinned and stacked through various methods. Recently, multilayer ceramic electronic components in which a thickness of the dielectric layer is decreased and the number of stacked dielectric layers is increased have been manufactured.

In addition, recently, ceramic electronic components of which a dielectric layer is formed using a fine ceramic powder for thinness of the dielectric layer have been manufactured.

Further, in accordance with miniaturization and high capacitance of electronic components, a thickness of a cover layer in which capacitance is not formed has also been decreased.

Meanwhile, as the multilayer ceramic electronic components have been used in technical fields requiring high reliability, for example, vehicle fields, medical device fields, or the like, high reliability multilayer ceramic electronic components have been demanded.

In securing high reliability, there may be present problems such as cracks in components due to external impacts, malfunction of apparatuses caused by the generation of cracks, and the like.

Research into a technology and a product for preventing warpage cracking from occurring in the multilayer ceramic electronic component has been continuously conducted, but there is a limitation.

In order to prevent the occurrence of short circuits due to warpage or cracks, a method of increasing a margin in the multilayer ceramic electronic component in a length direction, a method of using a lead frame at the time of mounting the multilayer ceramic electronic component on a board, a method of manufacturing an external electrode using an impact absorbing material, or the like, have been used.

However, the method of increasing the margin thereof in the length direction may be difficult to be applied to a high capacitance multilayer ceramic electronic component, and a method of applying a polymer material such as epoxy, or the like, to an external electrode may also have a limitation in securing bending strength.

Further, in the method of using a metal lead frame, there may be present problems such as high manufacturing costs and limitations in terms of a mounting area and height.

Therefore, research into a technology for improving bending strength characteristics simultaneously with preventing reliability from being deteriorated due to cracks remains required.

### SUMMARY

Some embodiments of the present disclosure may provide a multilayer ceramic capacitor and a board having the same mounted thereon.

According to some embodiments of the present disclosure, a multilayer ceramic capacitor may include: a ceramic body including dielectric layers; first and second internal electrodes disposed in the ceramic body so as to face each other, having the dielectric layer therebetween; and first and second external electrodes disposed to cover both end surfaces of the ceramic body. The ceramic body may include an active layer as a capacitance forming part and a cover layer as a non-capacitive part disposed on at least one surface of upper and lower surfaces of the active layer, the cover layer including at least one buffer layer therein, and when a thickness of the cover layer is defined as tc, and a thickness of the buffer layer is defined as ti, ti/tc being in a range of 0.15 to 0.90 (0.15≦ti/tc≦0.90).

In a cross-section of the ceramic body in a length-thickness direction thereof, a delamination region may be disposed in one or more of an interface between the cover layer and the buffer layer and the inside of the buffer layer.

The buffer layer may have a sintering shrinkage rate smaller than that of the dielectric layer.

The buffer layer may contain one or more selected from a group consisting of calcium (Ca), strontium (Sr), zirconium (Zr), and titanium (Ti).

The buffer layer may contain one or more selected from a group consisting of calcium (Ca), strontium (Sr), zirconium (Zr), and titanium (Ti), each of the one or more selected from the group having a content of 0.1 to 0.9 mol.

According to some embodiments of the present disclosure, a multilayer ceramic capacitor may include: a ceramic body including dielectric layers; first and second internal electrodes disposed in the ceramic body so as to face each other, having the dielectric layer therebetween; and first and second external electrodes disposed to cover both end surfaces of the ceramic body. The ceramic body may include an active layer as a capacitance forming part and a cover layer as a non-capacitive part disposed on at least one surface of upper and lower surfaces of the active layer, the cover layer including at least one buffer layer therein, and the buffer layer having a sintering shrinkage rate smaller than that of the dielectric layer.

In a cross-section of the ceramic body in a length-thickness direction thereof, a delamination region may be disposed in one or more of an interface between the cover layer and the buffer layer and the inside of the buffer layer.

The buffer layer may contain one or more selected from a group consisting of calcium (Ca), strontium (Sr), zirconium (Zr), and titanium (Ti).

The buffer layer may contain one or more selected from a group consisting of calcium (Ca), strontium (Sr), zirconium (Zr), and titanium (Ti), each of the one or more selected from the group having a content of 0.1 to 0.9 mol.

According to some embodiments of the present disclosure, a board having a multilayer ceramic capacitor mounted thereon may include: a printed circuit board having first and second electrode pads disposed thereon; and a multilayer ceramic capacitor mounted on the printed circuit board. The multilayer ceramic capacitor may include: a ceramic body including dielectric layers, first and second internal electrodes disposed in the ceramic body so as to face each other, having the dielectric layer therebetween, and first and second external electrodes disposed to cover both end surfaces of the ceramic body, the ceramic body including an active layer as a capacitance forming part and a cover layer as a non-capacitive part disposed on at least one surface of upper and lower surfaces of the active layer, the cover layer including at least one buffer layer therein, and when a thickness of the cover layer is defined as tc and a thickness of the buffer layer is defined as ti, ti/tc being in a range of 0.15 to 0.90 (0.15≦ti/tc≦0.90).

In a cross-section of the ceramic body in a length-thickness direction thereof, a delamination region may be disposed in one or more of an interface between the cover layer and the buffer layer and the inside of the buffer layer.

The buffer layer may have a sintering shrinkage rate smaller than that of the dielectric layer.

The buffer layer may contain one or more selected from a group consisting of calcium (Ca), strontium (Sr), zirconium (Zr), and titanium (Ti).

The buffer layer may contain one or more selected from a group consisting of calcium (Ca), strontium (Sr), zirconium (Zr), and titanium (Ti), each of the one or more selected from the group having a content of 0.1 to 0.9 mol.

### BRIEF DESCRIPTION OF DRAWINGS

The above and other aspects, features and other advantages of the present disclosure will be more clearly understood from the following detailed description taken in conjunction with the accompanying drawings, in which:

FIG. 1 is a perspective view schematically illustrating a multilayer ceramic capacitor according to an exemplary embodiment of the present disclosure;

FIG. 2 is a cross-sectional view taken along line B-B′ of FIG. 1;

FIG. 3 is an enlarged view of part S of FIG. 2;

FIG. 4 is a cross-sectional view of the multilayer ceramic capacitor according to the exemplary embodiment of the present disclosure, taken along line B-B′ of FIG. 1 and illustrating a shrinkage behavior therein at the time of sintering thereof;

FIG. 5 is a cross-sectional view taken along line B-B′ of FIG. 1 according to another embodiment of the present disclosure;

FIG. 6 is a cross-sectional view taken along line B-B′ of FIG. 1 according to another embodiment of the present disclosure; and

FIG. 7 is a perspective view illustrating a form in which the multilayer ceramic capacitor of FIG. 1 is mounted on a printed circuit board.

### DETAILED DESCRIPTION

Exemplary embodiments of the present disclosure will now be described in detail with reference to the accompanying drawings.

The disclosure may, however, be exemplified in many different forms and should not be construed as being limited to the specific embodiments set forth herein. Rather, these embodiments are provided so that this disclosure will be thorough and complete, and will fully convey the scope of the disclosure to those skilled in the art.

In the drawings, the shapes and dimensions of elements may be exaggerated for clarity, and the same reference numerals will be used throughout to designate the same or like elements.

Directions of a hexahedron will be defined to clearly describe exemplary embodiments of the present disclosure. L, W and T shown in the accompanying drawings refer to a length direction, a width direction, and a thickness direction, respectively. Here, the thickness direction may be the same as a stacking direction in which dielectric layers are stacked.

Further, in the exemplary embodiment of the present disclosure, for convenience of explanation, surfaces of a ceramic body on which first and second external electrodes are disposed, in the length direction of the ceramic body, may be defined as end surfaces opposing each other, and surfaces of the ceramic body opposing each other in the width direction may be defined as side surfaces thereof.

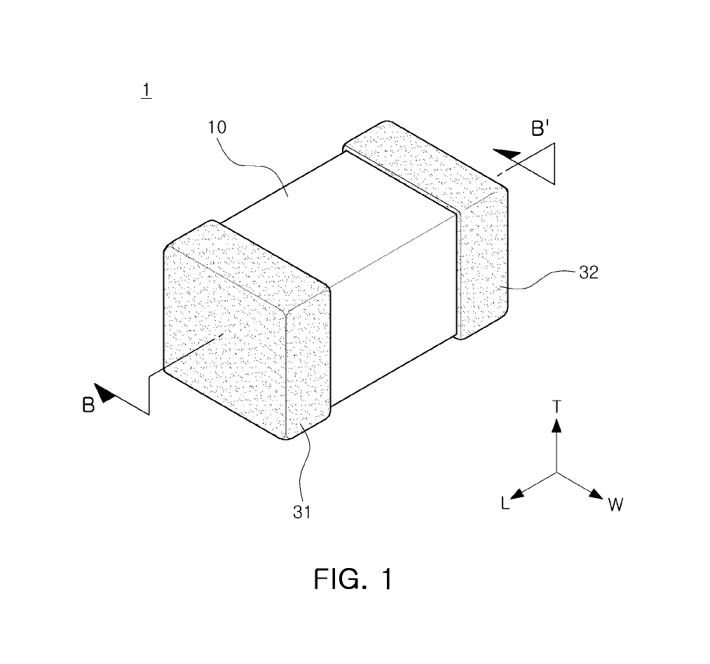

FIG. 1 is a perspective view schematically illustrating a multilayer ceramic capacitor according to an exemplary embodiment of the present disclosure.

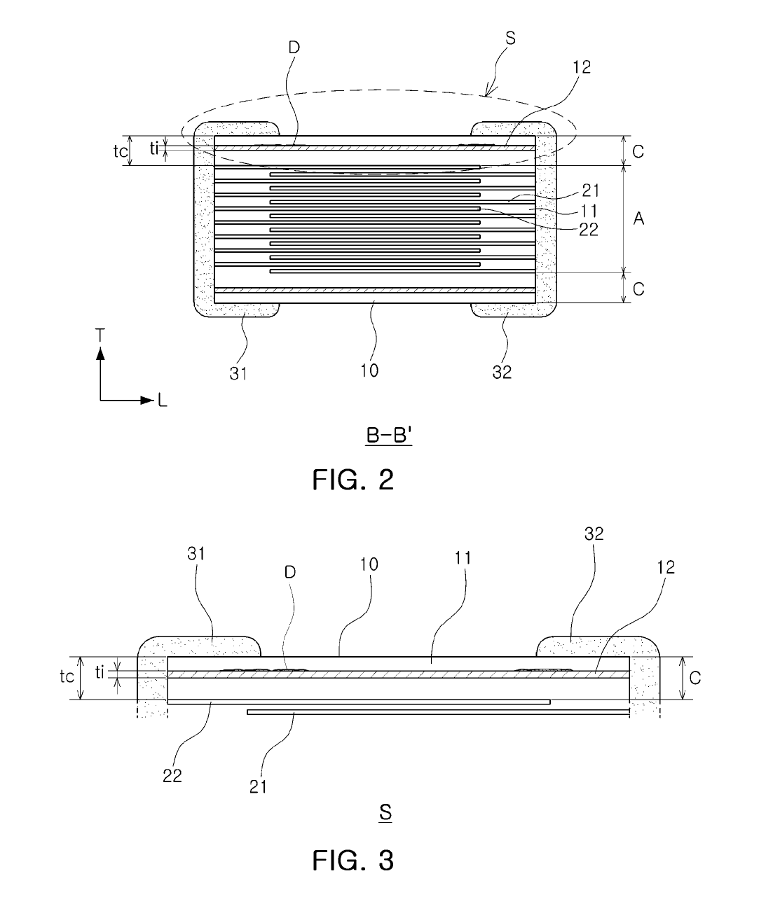

FIG. 2 is a cross-sectional view taken along line B-B′ of FIG. 1.

FIG. 3 is an enlarged view of part S of FIG. 2.

Referring to FIGS. 1 through 3, a multilayer ceramic electronic component according to an exemplary embodiment of the present disclosure may include: a ceramic body 10 including dielectric layers 11; first and second internal electrodes 21 and 22 disposed in the ceramic body 10 and disposed to face each other, having the dielectric layer 11 therebetween; and first and second external electrodes 31 and 32 disposed to cover both end surfaces of the ceramic body 10. The ceramic body 10 may include an active layer A corresponding to a capacitance forming part and a cover layer C corresponding to a non-capacitive part disposed on at least one surface of upper and lower surfaces of the active layer A, the cover layer C including at least one buffer layer 12 therein, and when a thickness of the cover layer C is defined as tc, and a thickness of the buffer layer 12 is defined as ti, ti/tc may be in a range of 0.15 to 0.90 (0.15≦ti/tc≦0.90).

The ceramic body 10 may be formed by stacking a plurality of dielectric layers 11 and then sintering the stacked dielectric layers. In this case, a shape and a dimension of the ceramic body 10 and the number of stacked dielectric layers 11 are not limited to those of the exemplary embodiment of the present disclosure shown in the accompanying drawings.

In addition, the plurality of dielectric layers 11 configuring the ceramic body 10 may be in a sintered state, and adjacent dielectric layers 11 may be integrated so as not to easily discern a boundary therebetween without using a scanning electron microscope (SEM).

This ceramic body 10 may include the active layer A as apart contributing to forming capacitance of the capacitor and the upper and lower cover layers C formed on and beneath the active layer A, respectively, as upper and lower margin parts.

The active layer A may be formed by repeatedly stacking the plurality of first and second internal electrodes 21 and 22, having the dielectric layer 11 therebetween.

In this case, a thickness of the dielectric layer 11 may be optionally changed according to the capacitance design of the multilayer ceramic capacitor 1, but a thickness of a single layer may be 0.1 to 10.0 μm after sintering. However, the present disclosure is not limited thereto.

Further, the dielectric layer 11 may contain a ceramic powder having high permittivity, for example, barium titanate (BaTiO₃) based powder or strontium titanate (SrTiO₃) based powder, or the like, but the present disclosure is not limited thereto.

The upper and lower cover layers C may have the same material and configuration as those of the dielectric layer 11 except that internal electrodes are not included therein.

The upper and lower cover layers C may be formed by stacking a single or two or more dielectric layers on the upper and lower surfaces of the active layer A in a thickness direction, respectively, and basically serve to prevent the first and second internal electrodes 21 and 22 from being damaged due to physical or chemical stress.

Meanwhile, the first and second internal electrodes 21 and 22, a pair of electrodes having different polarities, may be formed by printing a conductive paste containing a conductive metal on the dielectric layer 11 to a predetermined thickness.

In addition, the first and second internal electrodes 21 and 22 may be formed to be alternately exposed to both end surfaces in the stacking direction of the dielectric layers 11 and may be electrically insulated from each other by the dielectric layer 11 disposed therebetween.

For example, the first and second internal electrodes 21 and 22 may be electrically connected to the first and second external electrodes 31 and 32 through portions thereof alternately exposed to the both end surfaces of the ceramic body 10, respectively.

Therefore, when voltage is applied to the first and second external electrodes 31 and 32, electric charges are accumulated between the first and second internal electrodes 21 and 22 facing each other. In this case, capacitance of the multilayer ceramic capacitor 1 may be in proportion to an area of an overlapping region between the first and second internal electrodes 21 and 22.

A thickness of the first and second internal electrodes 21 and 22 may be determined according to the use thereof. For example, the thickness of the first and second internal electrodes 21 and 22 may be determined to be in a range of 0.2 to 1.0 μm in consideration of a size of the ceramic body 10, but the present disclosure is not limited thereto.

Further, the conductive metal contained in the conductive paste forming the first and second internal electrodes 21 and 22 may be nickel (Ni), copper (Cu), palladium (Pd), or an alloy thereof, but the present disclosure is not limited thereto.

Further, as a printing method of the conductive paste, a screen printing method, a gravure printing method, or the like, may be used, but the present disclosure is not limited thereto.

Meanwhile, the first and second external electrodes 31 and 32 may be formed of a conductive paste containing a conductive metal, and the conductive metal may be nickel (Ni), copper (Cu), palladium (Pd), gold (Au), or an alloy thereof, but the present disclosure is not limited thereto.

According to an exemplary embodiment of the present disclosure, the cover layer C may include at least one buffer layer 12 therein.

Generally, as a multilayer ceramic electronic component is used in technical fields requiring high reliability, for example, vehicle fields, medical device fields, or the like, multilayer ceramic electronic components are required to have high reliability.

In securing high reliability, there may be present problems such as the occurrence of cracks in components due to external impacts, malfunction of an apparatus caused by the occurrence of cracks, and the like.

In detail, at the time of mounting a multilayer ceramic capacitor on a board, cracks started to occur in a distal end of an external electrode due to warpage of the board may spread to the inside thereof to affect a region in which internal electrodes are stacked, which is an active layer, thereby deteriorating reliability.

According to an exemplary embodiment of the present disclosure, the cover layer C may include at least one buffer layer 12 therein, such that the above-mentioned problem, for example, the problem of affecting the active layer due to the occurrence of cracks to deteriorate reliability, may be solved.

For example, bending strength characteristics of the multilayer ceramic capacitor may be improved, and deterioration of reliability thereof due to the occurrence of cracks may be prevented by stacking the buffer layer 12 in the cover layer so as to be disposed upwardly of an outermost internal electrode of the ceramic body in the thickness direction thereof, and adjusting the number of buffer layers and a thickness thereof.

Although the case in which each of the upper and lower cover layers C includes a single buffer layer 12 is shown in FIG. 2, the present disclosure is not limited thereto. For example, the buffer layer may be included in only the upper or lower cover layer C, or two or more buffer layers may be included in the cover layer C.

Hereinafter, operation of preventing cracks from spreading into the capacitor by including at least one or more buffer layers 12 in the cover layer C will be described in detail.

The buffer layer 12 may have a sintering shrinkage rate smaller than that of the dielectric layer 11.

The buffer layer 12 is formed to have the sintering shrinkage rate smaller than that of the dielectric layer 11, such that at the time of sintering the ceramic body 10, an active layer A region may be further shrunk as compared to a region in which the buffer layer 12 is formed.

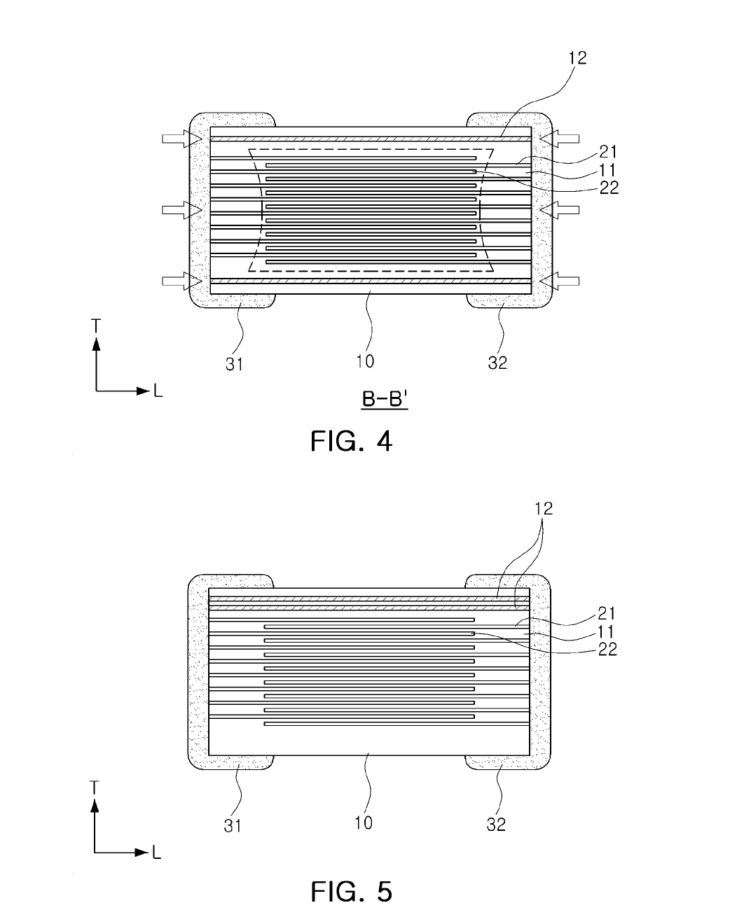

FIG. 4 is a cross-sectional view Of the multilayer ceramic capacitor according to the exemplary embodiment of the present disclosure, taken along line B-B′ of FIG. 1 and illustrating a shrinkage behavior therein at the time of sintering thereof

Referring to FIG. 4, it may be appreciated that since the buffer layer 12 has a sintering shrinkage rate smaller than that of the dielectric layer 11, at the time of sintering, a shrinkage rate of the buffer layer 12 is smaller than that of the dielectric layer 11.

Due to a difference in the sintering shrinkage rate between the buffer layer 12 and the dielectric layer 11, in a cross-section of the ceramic body 10 in a length-thickness direction thereof, a delamination region D may be formed in at least one of an interface between the cover layer C and the buffer layer 12 and the inside of the buffer layer 12.

For example, since the cover layer C is made of the same ceramic green sheet as that of the dielectric layer 11, stress due to a difference in the sintering shrinkage rate may be generated in the interface between the cover layer C and the buffer layer 12.

The delamination region D may be formed in at least one of the interface between the cover layer C and the buffer layer 12 and the inside of the buffer layer 12 due to the difference in the stress.

The spreading of cracks generated due to warpage of a board at the time of mounting the multilayer ceramic capacitor on the board to the region in which the internal electrodes are stacked, the active layer, may be prevented due to the delamination region D.

For example, the delamination region D serves as a crack spread prevention region preventing the cracks from spreading, such that deterioration of reliability due to the cracks occurring at the time of mounting the capacitor on the board may be prevented.

In an exemplary embodiment of the present disclosure, the buffer layer 12 may contain one or more selected from a group consisting of calcium (Ca), strontium (Sr), zirconium (Zr), and titanium (Ti).

Further, the buffer layer 12 may contain one or more selected from a group consisting of calcium (Ca), strontium (Sr), zirconium (Zr), and titanium (Ti), at a content of 0.1 to 0.9 mol of each contained therein.

The buffer layer 12 may contain one or more selected from a group consisting of calcium (Ca), strontium (Sr), zirconium (Zr), and titanium (Ti), such that the buffer layer 12 may have a sintering shrinkage rate smaller than that of the dielectric layer 11.

Further, the buffer layer 12 may contain one or more selected from a group consisting of calcium (Ca), strontium (Sr), zirconium (Zr), and titanium (Ti), at a content of 0.1 to 0.9 mol of each contained therein, but is not limited thereto.

Therefore, the bending strength characteristics may be improved, and deterioration of reliability due to the occurrence of cracks may be prevented by adjusting the number and thickness of buffer layer 12.

In further detail, when the thickness of the cover layer C is defined as tc, and the thickness of the buffer layer 12 is defined as ti, ti/tc is may be in a range of 0.15 to 0.90 (0.15≦ti/tc≦0.90).

When the thickness of the cover layer C is defined as tc, and the thickness of the buffer layer 12 is defined as ti, the bending strength characteristics of the multilayer ceramic capacitor may be improved, and deterioration of reliability due to the occurrence of cracks may be prevented by adjusting ti/tc so as to be in a range of 0.15 to 0.90 (0.15≦ti/tc≦0.90).

In the case in which a ratio ti/tc of the thickness ti of the buffer layer 12 to the thickness tc of the cover layer C is less than 0.15, cracks may spread to the inside of the capacitor by passing through the buffer layer 12, such that there may be present a problem in terms of reliability.

In the case in which the ratio ti/tc of the thickness ti of the buffer layer 12 to the thickness tc of the cover layer C is more than 0.90, since delamination may be excessively generated during a sintering process of a chip, cracks may be observed externally, such that there may be a problem in terms of reliability.

FIG. 5 is a cross-sectional view taken along line A-A′ of FIG. 1 according to another embodiment of the present disclosure.

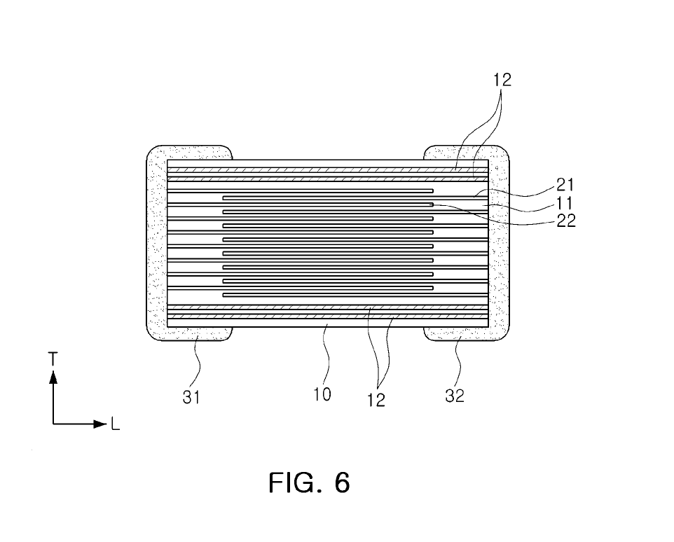

FIG. 6 is a cross-sectional view taken along line B-B′ of FIG. 1 according to another embodiment of the present disclosure.

Referring to FIG. 5, the multilayer ceramic capacitor according to another exemplary embodiment of the present disclosure may include two buffer layers 12 only in an upper cover layer among upper and lower cover layers C. In addition, referring to FIG. 6, the multilayer ceramic capacitor according to another exemplary embodiment of the present disclosure may include two buffer layers 12 in each of the upper and lower cover layers C.

Although the buffer layer having various shapes are shown in FIGS. 5 and 6, the present disclosure is not limited thereto, and there is no particular limitation in the number of the buffer layers 12 and a formation position thereof.

Meanwhile, the multilayer ceramic capacitor according to another exemplary embodiment of the present disclosure my include a ceramic body including dielectric layers; first and second internal electrodes disposed in the ceramic body so as to face each other, having the dielectric layer therebetween; and first and second external electrodes formed to cover both end surfaces of the ceramic body. The ceramic body may include an active layer corresponding to a capacitance forming part and a cover layer corresponding to a non-capacitive part formed on at least one surface of upper and lower surfaces of the active layer, the cover layer including at least one buffer layer therein, and the buffer layer having a sintering shrinkage rate smaller than that of the dielectric layer.

In an exemplary embodiment of the present disclosure, in a cross-section of the ceramic body in a length-thickness direction, a delamination region may be formed in one or more of an interface between the cover layer and the buffer layer and the inside of the buffer layer.

In an exemplary embodiment of the present disclosure, the buffer layer may contain one or more selected from a group consisting of calcium (Ca), strontium (Sr), zirconium (Zr), and titanium (Ti).

In an exemplary embodiment of the present disclosure, the buffer layer may contain one or more selected from a group consisting of calcium (Ca), strontium (Sr), zirconium (Zr), and titanium (Ti), at the content of 0.1 to 0.9 mol of each contained therein.

In describing the multilayer ceramic capacitor according to another exemplary embodiment of the present disclosure, a description overlapped with the description of the above-mentioned multilayer ceramic electronic component according to the exemplary embodiment of the present disclosure will be omitted.

In a manufacturing method of a multilayer ceramic electronic component according to an exemplary embodiment of the present disclosure, first, a ceramic green sheet may be prepared using a slurry containing a ceramic powder and additives.

The ceramic green sheet may be manufactured by mixing a ceramic powder, a binder, and a solvent to prepare a slurry and manufacturing the prepared slurry as a sheet having a thickness of several μm by a doctor blade method.

Then, an internal electrode pattern may be formed on the ceramic green sheet using a conductive metal paste.

Next, a green sheet on which the internal electrode pattern is formed may be stacked and sintered, thereby forming a ceramic body including dielectric layers and first and second internal electrodes disposed to face each other, having the dielectric layer therebetween.

The ceramic body of the multilayer ceramic electronic component manufactured by the manufacturing method according to another exemplary embodiment of the present disclosure may include an active layer corresponding to a capacitance forming part and a cover layer corresponding to a non-capacitive part formed on at least one surface of upper and lower surfaces of the active layer. The cover layer may include at least one buffer layer therein.

Other features overlapped with those of the multilayer ceramic electronic component according to the foregoing exemplary embodiment of the present disclosure will be omitted.

Hereinafter, although the present disclosure will be described in detail with reference to Inventive Examples, the present disclosure is not limited thereto.

In the Inventive Example, a test for evaluating bending strength characteristics according to a ratio ti/tc of a thickness ti of the buffer layer 12 to a thickness tc of the cover layer C was performed on a multilayer ceramic capacitor including an active layer, which is a capacitance forming part, a cover layer, which is a non-capacitive part, formed on at least one surface of upper and lower surfaces of the active layer, and at least one buffer layer in the cover layer.

The multilayer ceramic capacitor according to Inventive Example was manufactured as follows.

First, a slurry containing a powder such as barium titanate (BaTiO₃) powder, or the like, was applied to and dried on a carrier film to prepare a plurality of ceramic green sheets, thereby forming dielectric layers.

Next, a conductive paste for an internal electrode was prepared, applied to the green sheet by a screen printing method to form an internal electrode, and then stacked, thereby manufacturing a multilayer body.

In detail, the ceramic green sheet was additionally stacked on upper and lower portions of the multilayer body so as to include at least one or more buffer layers between the stacked ceramic green sheets to thereby form upper and lower cover layers, thereby manufacturing the multilayer body.

Then, the multilayer body was compressed and cut to thereby form 1608 standard-sized chips, and the chips were sintered at 1050 to 1200° C. under reduction atmosphere in which H₂ is 0.1% or less.

Next, processes such as an external electrode forming process, a plating process, and the like, were performed, thereby manufacturing the multilayer ceramic capacitor.

The following Table 1 shows data obtained by comparing the bending strength characteristics according to the ratio ti/tc of the thickness ti of the buffer layer 12 to the thickness tc of the cover layer C.

TABLE 1

| | | | | Before |
|---|---|---|---|---|
| | | After Evaluating Bending | | Evaluating |
| | | strength | | Bending |
| | | | Amount of Cracks | strength |
| | | | Spread to The | Amount of |
| | | Amount of | Inside by Passing | Cracks |
| | | Cracks In | through Buffer | Observed |
| | Ti/tc | Buffer Layer | Layer | Externally |
| *1 | 0.08 | 0/100 | 12/100 | 0/100 |
| *2 | 0.10 | 1/100 | 5/100 | 0/100 |
| *3 | 0.13 | 5/100 | 2/100 | 0/100 |
| 4 | 0.15 | 13/100 | 0/100 | 0/100 |
| 5 | 0.16 | 15/100 | 0/100 | 0/100 |
| 6 | 0.20 | 14/100 | 0/100 | 0/100 |
| 7 | 0.25 | 16/100 | 0/100 | 0/100 |
| 8 | 0.32 | 12/100 | 0/100 | 0/100 |
| 9 | 0.37 | 12/100 | 0/100 | 0/100 |
| 10 | 0.40 | 16/100 | 0/100 | 0/100 |
| 11 | 0.50 | 13/100 | 0/100 | 0/100 |
| 12 | 0.56 | 12/100 | 0/100 | 0/100 |
| 13 | 0.60 | 15/100 | 0/100 | 0/100 |
| 14 | 0.70 | 13/100 | 0/100 | 0/100 |
| 15 | 0.80 | 13/100 | 0/100 | 0/100 |
| 16 | 0.86 | 12/100 | 0/100 | 0/100 |
| 17 | 0.90 | 14/100 | 0/100 | 0/100 |
| *18 | 0.91 | 13/100 | 0/100 | 2/100 |
| *19 | 0.93 | 16/100 | 0/100 | 5/100 |
| *20 | 0.95 | 15/100 | 0/100 | 12/100 |

*Comparative Example

Referring to [Table 1], it may be appreciated that in the case of samples 4 to 17 of Inventive Examples, in which the ratio ti/tc of the thickness ti of the buffer layer 12 to the thickness tc of the cover layer C is in a range of 0.15 to 0.90 (0.15≦ti/tc≦0.90), even when cracks are generated, the generated cracks do not spread to the inside, such that a bending strength test result is good.

On the other hand, it could be appreciated that in the case of samples 1 to 3 of Comparative Examples, since the thickness of the buffer layer 12 was relatively thin, cracks spread to the inside, such that there was present a problem in terms of reliability, and in the case of samples 18 to 20 of Comparative Examples, since delamination was excessively generated during a sintering process of the chip, cracks were observed externally, such that there was present a problem in terms of reliability.

Board Having Multilayer Ceramic Capacitor Mounted Thereon

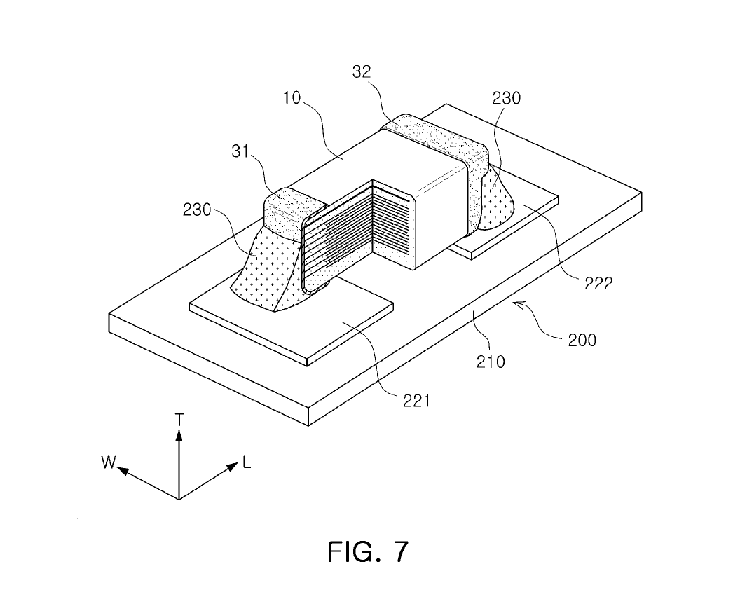

FIG. 7 is a perspective view illustrating a form in which the multilayer ceramic capacitor of FIG. 1 is mounted on a printed circuit board.

Referring to FIG. 7, a board 200 having a multilayer ceramic capacitor mounted thereon according to the exemplary embodiment of the present disclosure may include a printed circuit board 210 on which the multilayer ceramic capacitor is horizontally mounted and first and second electrode pads 221 and 222 formed on the printed circuit board 210 to be spaced apart from each other.

In this case, the multilayer ceramic capacitor may be electrically connected to the printed circuit board 210 by a soldering 230 in a state in which first and second external electrodes 31 and 32 are positioned on the first and second electrode pads 221 and 222 so as to contact each other, respectively.

In the multilayer ceramic capacitor according to an exemplary embodiment of the present disclosure, since the cover layer includes at least one buffer layer therein, and the ratio ti/tc of the thickness ti of the buffer layer 12 to the thickness tc of the cover layer C is in a range of 0.15 to 0.90 (0.15≦ti/tc≦0.90), even in a case in which warpage cracking is generated at the time of mounting the multilayer ceramic capacitor on the board, the spreading of warpage cracking to the inside may be prevented, such that reliability thereof may be relatively excellent.

According to exemplary embodiments of the present disclosure, bending strength characteristics of the multilayer ceramic electronic component may be improved, and deterioration of reliability due to the occurrence of cracks may be prevented by stacking the buffer layer having a sintering shrinkage rate smaller than that of the dielectric layer in the upper and lower cover layers, for example, to be disposed upwardly of the outermost internal electrode of the ceramic body in the thickness direction thereof.

While exemplary embodiments have been shown and described above, it will be apparent to those skilled in the art that modifications and variations could be made without departing from the spirit and scope of the present disclosure as defined by the appended claims.

What is claimed is:

1. A multilayer ceramic capacitor comprising:
a ceramic body including dielectric layers;
first and second internal electrodes disposed in the ceramic body so as to face each other, the dielectric layer being interposed between the first and second internal electrodes; and
first and second external electrodes disposed to cover both end surfaces of the ceramic body,
wherein the ceramic body includes an active layer as a capacitance forming part and a cover layer as a non-capacitive part disposed on at least one surface of upper and lower surfaces of the active layer, the cover layer including at least one buffer layer therein, and when a thickness of the cover layer is defined as tc and a thickness of the buffer layer is defined as ti, ti/tc is in a range of 0.15 to 0.90 (0.15≦ti/tc≦0.90).

2. The multilayer ceramic capacitor of claim 1, wherein in a cross-section of the ceramic body in a length-thickness direction, a delamination region is disposed in at least one of an interface between the cover layer and the buffer layer and the inside of the buffer layer.

3. The multilayer ceramic capacitor of claim 1, wherein the buffer layer has a sintering shrinkage rate smaller than that of the dielectric layer.

4. The multilayer ceramic capacitor of claim 1, wherein the buffer layer contains one or more selected from a group consisting of calcium (Ca), strontium (Sr), zirconium (Zr), and titanium (Ti).

5. The multilayer ceramic capacitor of claim 4, wherein the buffer layer contains one or more selected from a group consisting of calcium (Ca), strontium (Sr), zirconium (Zr), and titanium (Ti), each of the one or more selected from the group having a content of 0.1 to 0.9 mol.

6. A multilayer ceramic capacitor comprising:
a ceramic body including dielectric layers;
first and second internal electrodes disposed in the ceramic body so as to face each other, having the dielectric layer therebetween; and
first and second external electrodes disposed to cover both end surfaces of the ceramic body,
wherein the ceramic body includes an active layer as a capacitance forming part and a cover layer as a non-capacitive part disposed on at least one surface of upper and lower surfaces of the active layer, the cover layer including at least one buffer layer therein, and the buffer layer having a sintering shrinkage rate smaller than that of the dielectric layer.

7. The multilayer ceramic capacitor of claim 6, wherein in a cross-section of the ceramic body in a length-thickness direction, a delamination region is disposed in one or more of an interface between the cover layer and the buffer layer and the inside of the buffer layer.

8. The multilayer ceramic capacitor of claim 6, wherein the buffer layer contains one or more selected from a group consisting of calcium (Ca), strontium (Sr), zirconium (Zr), and titanium (Ti).

9. The multilayer ceramic capacitor of claim 8, wherein the buffer layer contains one or more selected from a group consisting of calcium (Ca), strontium (Sr), zirconium (Zr), and titanium (Ti), each of the one or more selected from the group having a content of 0.1 to 0.9 mol.

10. A board having a multilayer ceramic capacitor mounted thereon, the board comprising:
a printed circuit board having first and second electrode pads disposed thereon; and
a multilayer ceramic capacitor mounted on the printed circuit board,
wherein the multilayer ceramic capacitor includes: a ceramic body including dielectric layers, first and second internal electrodes disposed in the ceramic body so as to face each other, having the dielectric layer therebetween, and first and second external electrodes disposed to cover both end surfaces of the ceramic body, the ceramic body including an active layer as a capacitance forming part and a cover layer as a non-capacitive part disposed on at least one surface of upper and lower surfaces of the active layer, the cover layer including at least one buffer layer therein, and when a thickness of the cover layer is defined as tc, and a thickness of the buffer layer is defined as ti, ti/tc being in a range of 0.15 to 0.90 (0.15≦ti/tc≦0.90).

11. The board of claim 10, wherein in a cross-section of the ceramic body in a length-thickness direction, a delamination region is disposed in one or more of an interface between the cover layer and the buffer layer and the inside of the buffer layer.

12. The board of claim 10, wherein the buffer layer has a sintering shrinkage rate smaller than that of the dielectric layer.

13. The board of claim 10, wherein the buffer layer contains one or more selected from a group consisting of calcium (Ca), strontium (Sr), zirconium (Zr), and titanium (Ti).

14. The board of claim 13, wherein the buffer layer contains one or more selected from a group consisting of calcium (Ca), strontium (Sr), zirconium (Zr), and titanium (Ti), each of the one or more selected from the group having a content of 0.1 to 0.9 mol.
